(19) United States
(12) Patent Application Publication
(10) Pub. No.: US 2026/0148634 A1
(43) Pub. Date: May 28, 2026

(54) METHOD AND INFORMATION SYSTEM FOR DELIVERING WARNING INFORMATION IN AN INFORMATION SYSTEM

(71) Applicant: AUDI AG, Ingolstadt (DE)

(72) Inventors: Benedikt Nilges, Ingolstadt (DE); Rico Steinz, Ingolstadt (DE); Herbert Ehrentraut, Beilngries (DE)

(73) Assignee: AUDI AG, Ingolstadt (DE)

(21) Appl. No.: 19/353,375

(22) Filed: Oct. 8, 2025

(30) Foreign Application Priority Data
Oct. 9, 2024 (DE) 10 2024 129 189.3

(51) Int. Cl. G08B 27/00; G08B 21/02; G08B 25/10

(52) U.S. Cl. CPC G08B 27/00; G08B 21/02; G08B 25/10

(57) ABSTRACT

A method for delivering warning information in an information system and an information system are provided herein. The information system comprising a satellite network and a plurality of user terminals, warning information being transmitted to at least one user terminal among the plurality of user terminals of the information system. According to the method, the warning information is entered into the information system by a user who notifies the information system by way of a user terminal of the user and/or via the satellite network and the warning information is transmitted via the satellite network to the at least one user terminal among the plurality of user terminals of the information system that is associated with another user.

### CROSS REFERENCE TO RELATED APPLICATIONS

This application is a based upon and claims the priority benefit of German Application No. 10 2024 129 189.3 filed on Oct. 9, 2024, the entire contents of which are incorporated by reference herein.

### BACKGROUND

### 1. Field

The invention relates to an information system and a method for delivering warning

information in an information system.

An incident that is an exceptional situation, such as a flood or fire, in a geographical region requires people who are in or approaching that region to be informed of the exceptional situation.

Terrestrial mobile radio networks are already being used for this purpose. This involves the information about the exceptional situation being sent to all terminals within a mobile radio cell. This type of transmission is also referred to as a cell broadcast. A disadvantage of this type of transmission is that there is no coverage by the conventional mobile radio network in remote regions.

### 2. Description of the Related Art

In addition, DE 10 2006 003 702 B3 discloses a global information and risk warning system using satellite navigation systems and user terminals. This involves hazardous situations for a specific area being identified, for example by sensor, by monitoring systems. The monitoring system comprises in particular a control center and multiple monitoring stations. The information acquired by the monitoring stations can be transmitted to a control center of the satellite navigation system via the control center of the monitoring system.

A disadvantage of this information and risk warning system is that, in addition to the information and risk warning system, a monitoring system is required, which comprises in particular a control center and multiple monitoring stations; and the acquirable/identifiable information and risks are limited to information and risks that can be acquired/identified by the monitoring stations, which, for example, are equipped with sensors and are stationary stations.

### SUMMARY

One object of the present invention, according to an aspect of the present invention, is to provide a solution by means of which warning information can be acquired and selectively transmitted to users.

The objects of the present invention are achieved by the subject matter of the independent patent claims. Advantageous further developments of the invention are described by the dependent claims, the description that follows and the figures.

According to one aspect, the present invention relates to a method for delivering warning information in an information system, the information system comprising a satellite network and a plurality of user terminals and the warning information being transmitted to at least one user terminal among the plurality of the user terminals of the information system. According to the method, the warning information is entered into the information system by a user who notifies the information system by way of a user terminal of the user and/or via the satellite network and is transmitted via the satellite network to the at least one user terminal that is associated with at least one other user.

An information system refers to a communication system that can be used to transmit warning information to at least one user. In addition, the inventive information system, according to an aspect, allows the warning information to be entered into the information system by a user.

According to an aspect of the present invention, the information system comprises a satellite network and a plurality of user terminals. The satellite network comprises a plurality of satellites and at least one management unit. The management unit is in particular a unit that is enabled to monitor and/or control the entire satellite network. Preferably, according to an aspect of the present invention, the management unit has a distribution unit in which one of the plurality of satellites can be selected for transmitting the warning information. In addition, there can be provision in the management unit and/or each of the satellites for a selection unit for selecting one of multiple satellite beams of a satellite. The satellite network can be a satellite communication network and/or satellite navigation network. If the satellite network is a satellite navigation network, it is designed to allow bidirectional communication to take place between user terminals and satellites.

According to an aspect of the present invention, a user terminal preferably has a user interface that can be used to input information into the user terminal and to output information from the user terminal. Preferably, according to an aspect of the present invention, a user terminal is associated with a motor vehicle. In particular a user terminal that is integrated in the motor vehicle and/or networked thereto for communication purposes is referred to as being associated with a motor vehicle. The user terminal is therefore preferably a mobile user terminal. It can be in the form of e.g. an infotainment system or telematics system for the motor vehicle or in the form of a portable user terminal, e.g. a smartphone.

According to an aspect of the present invention, delivering warning information in the information system comprises entering the information into the information system and transmitting the information in the information system. In addition, delivering can also comprise outputting the warning information to the user.

Warning information refers to information that indicates an incident that is at least potentially a threat and/or restriction for a user. A threat is understood to be in particular an incident that puts the user's safety at risk. Threats can be forest fires, landslides, floods or the like, for example. A restriction is understood to be for example the restriction of a possible path of the user. Such a restriction can be a closure of a section of the path or of the entire path. Restrictions can be for example a fallen tree, a collapsed bridge and the like. If a forest fire is near a road, for example, this incident is both a threat and a restriction for the user.

According to an aspect of the present invention, the warning information is transmitted to at least one user terminal of the information system. This transmission takes place via the satellite network, can take place via one or more satellites and can preferably take place by way of one of multiple satellite beams of a satellite.

According to an aspect of the present invention, the warning information is entered into the information system via the satellite network by a notifying user of the information system. The warning information is entered via the satellite network in particular by way of the user terminal of the notifying user. To clarify an aspect of the present invention by way of illustration, there could alternatively also be provision for the warning information to be able to be entered by way of a device that is not used as a user terminal of the information system, i.e. to which the warning information is transmitted, from where said information could be entered via an interface of the satellite network, e.g. a control station.

The term “notifying user” is used to distinguish said user from other users of the information system, in particular from users who merely receive the warning information via the information system. A notifying user therefore refers to the user who enters warning information into the information system. Preferably, the notifying user is the driver and/or keeper of the motor vehicle.

As a result of the warning information being entered into the information system via the satellite network by a user of the information system, in particular the notifying user, it can firstly be ensured that alerts relating to regions where there is no provision for stationary sensors of a monitoring system can also be delivered in the information system. Secondly, as the information is entered into the information system via the satellite network, alerts relating to a region that is not covered by other communication networks, in particular mobile radio networks, can also be entered into the information system. In addition, as a result of the alerts being transmitted to the user terminal of at least one other user via the satellite network, the entered alerts can also be transmitted to user terminals of other users situated in a region that is not covered by other communication networks, in particular mobile radio networks. Finally, an aspect of the present invention allows the warning information to be provided promptly after the occurrence of the incident and the parameters of the alert, in particular the position of the incident, to be precisely defined.

According to one embodiment, the warning information is generated by the notifying user. This embodiment has the advantage that the warning can be matched to the actual incident.

In particular, the user can indicate the incident and the magnitude thereof, for example. Preferably, the warning information is generated by the notifying user using an entry unit. The entry unit may be connected to or integrated in the user terminal of the notifying user.

According to one embodiment, the warning information comprises at least two parameters, which are the incident and the position of the incident. These parameters can define the incident. The warning information can contain other parameters. For example, the suspected extent of the incident and/or an incident type can be other parameters.

According to one embodiment, the warning information is generated by the notifying user using an entry unit that predetermines a list for selection by the user for at least one parameter of the warning information.

The entry unit may be integrated in the user terminal or may be a separate unit connected to the user terminal.

The position of the incident can be indicated by the notifying user. According to one embodiment, however, the position of the incident is determined by the entry unit, the user terminal or a unit connected thereto. In particular, the position of the incident can be determined by means of position information determined by the satellite network. In this embodiment, in particular the position information of the user terminal of the notifying user that has been determined by the satellite network can be used as the position of the incident or displayed to the notifying user as an option in a selection list. In this embodiment, the satellite network is a satellite navigation network having communication capabilities.

Lists of options for the parameters of the warning information may be stored in the entry unit or can be output on the entry unit. In particular, a list of options may be predefined for selection by the user. This allows the warning information generated on the basis of the selections by the notifying user to be in a predefined format.

According to one embodiment, the warning information is transmitted to user terminals situated in the surroundings of the position of the incident. For this purpose, a satellite or satellite beam whose footprint covers at least the position of the incident can be selected in the distribution point for the purpose of transmitting the warning information to user terminals.

According to one embodiment, the warning information is entered by the notifying user, in particular by means of the user terminal associated with that user, by way of a satellite beam of a satellite of the satellite network and is transmitted to the user terminal of at least one other user by way of that satellite beam. Since the footprint of the satellite beam by way of which the warning information is entered covers the position of an incident that has occurred in the surroundings of the user terminal of the notifying user, use of the same satellite beam can easily ensure that the warning information is transmitted to user terminals that are near the incident. This allows users to be reliably informed about the incident and, if necessary, to change their path or route to avoid the incident.

According to one embodiment, each of the user terminals can be switched between a communication mode for communication via a mobile radio network and a communication mode for communication via the satellite network. This switching preferably takes place automatically when a lack of coverage by a mobile radio network is detected. If sufficient coverage by a mobile radio network is subsequently detected, there is preferably an automatic switch back to the communication mode for communication via the mobile radio network.

According to another aspect, the present invention relates to an information system for delivering warning information in an information system, the information system comprising a satellite network and a multiplicity of user terminals. The information system is characterized in that the satellite network is designed to transmit to at least one of the user terminals of the information system and the information system comprises an entry unit that a notifying user can use to enter warning information into the information system.

Advantages and features described with regard to the inventive method apply accordingly to the inventive information system and vice versa, where applicable.

According to one embodiment, the entry unit is connected to or integrated in the user terminal of the notifying user. Preferably, there is provision for an entry unit on or in each user terminal of the information system so that warning information can be entered by way of any of the user terminals.

According to one embodiment, the entry unit comprises a user interface that the notifying user can use to input parameters of the alerts. Parameters can also be input by selecting an option from a list of options for each parameter.

According to another embodiment, each of the user terminals comprises a switching device for switching between a communication mode for communication via a mobile radio network and a communication mode for communication via the satellite network.

The present invention also comprises the combinations of the features of the embodiments described. The present invention thus also comprises implementations that each have a combination of the features of multiple instances of the embodiments described, unless the embodiments have been described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

Exemplary embodiments of the invention are described below. In this regard:

FIG. 1 shows a schematic block diagram of an embodiment of an inventive information system;

FIG. 2 shows a schematic block diagram of an embodiment of a user terminal;

FIG. 3 shows a schematic representation of an embodiment of the inventive method;

FIG. 4 shows a schematic representation of another embodiment of the inventive method.

### DETAILED DESCRIPTION

Reference will now be made in detail to the preferred embodiments, examples of which are illustrated in the accompanying drawings, wherein like reference numerals refer to like elements throughout.

The exemplary embodiments outlined below are preferred embodiments of the invention. In the exemplary embodiments, the described components of the embodiments are each individual features of the invention that are intended to be considered independently of one another and that each also develop the invention independently of one another. Therefore, the disclosure is intended to also comprise combinations of the features of the embodiments other than those illustrated. Furthermore, the embodiments described can also be supplemented by other instances of the features of the invention that have already been described.

In the figures, identical reference signs denote functionally identical elements in each case.

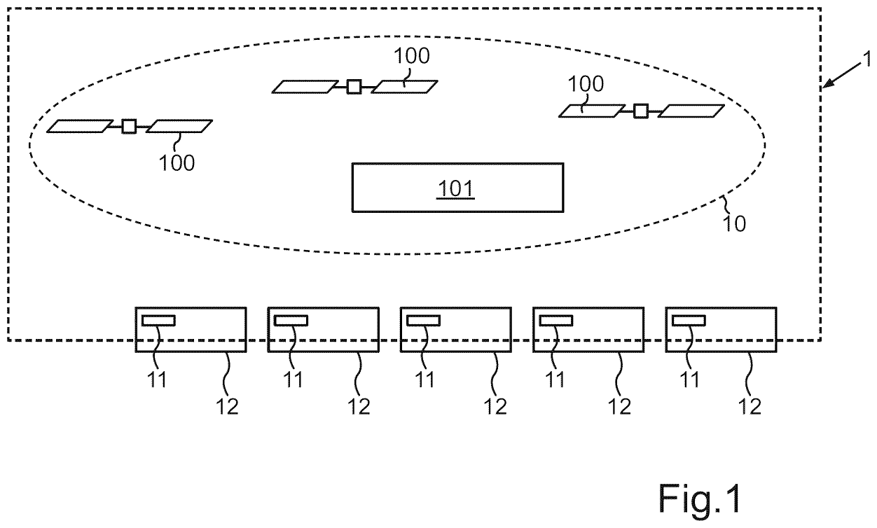

FIG. 1 schematically shows an embodiment of the inventive information system 1. The information system 1 comprises a satellite system 10 and a multiplicity of user terminals 11. FIG. 1 shows five user terminals 11. In the embodiment shown, each of the user terminals 11 is integrated in a motor vehicle 12. The satellite network 10 comprises at least one management unit 101 and a multiplicity of satellites 100. FIG. 1 shows only three satellites 100. The satellite network 10 is a satellite network having communication capabilities for communication, preferably bidirectional communication, between the user terminals 11 and the satellites 100.

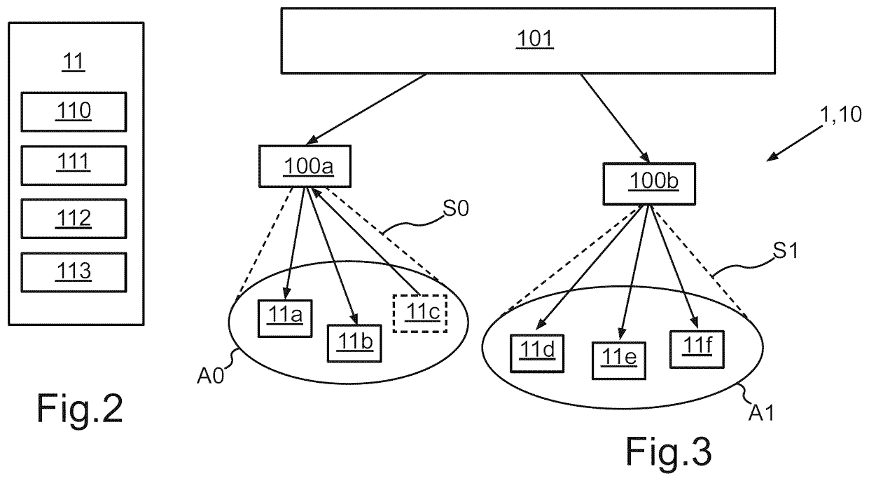

In this regard, each of the user terminals 11 is designed to communicate with the satellites 100. An embodiment of a user terminal 11 is shown schematically in FIG. 2. In the embodiment shown, the user terminal 11 has an antenna 111, a modem 112, a switching device 113 and an entry unit 110. In the embodiment shown, the entry unit 110 is integrated in the user terminal 11. However, the entry unit 110 may also be a separate unit from the user terminal 11 and be connected to the user terminal 11 merely for the purpose of communication. The entry unit 110 preferably has a user interface (not shown). Alternatively, the user interface of the user terminal 11 can be used as the user interface of the entry unit 110. The user interface can be used by the user to input information into the entry unit 110 and, if necessary, to visually or audibly output information. In particular, the entry unit 110 can be used by the user to input information about parameters relating to an incident. In addition, warning information can be produced in the entry unit 110 or a processing unit (not shown) in the user terminal 11 on the basis of inputs by the user. This warning information can be transmitted to a unit of the satellite network 10 by way of the user terminal 11. In the satellite network 10, the satellite 100 or a satellite beam of one of the satellites 100 by way of which the warning information is intended to be transmitted to at least one user terminal 11 can be selected. Preferably, the warning information is transmitted to a multiplicity of user terminals 11, at least one of the user terminals 11 preferably being a user terminal 11 that is different than the user terminal 11 from which the warning information was entered. This means that warning information entered by a notifying user can be sent to at least one other user

FIG. 3 schematically shows a first embodiment of the inventive method.

FIG. 3 shows only one management unit 101 and two satellites 100a, 100b of a satellite network 10 from the information system. The satellite beam S0 of the satellite 100a covers a footprint A0 and the satellite beam S1 of the satellite 100b covers a footprint A1, which is spaced apart from the footprint A0. At the time shown in FIG. 3, three user terminals 11a, 11b, 11c are situated in the footprint S0 and three user terminals 11d, 11e, 11f are situated in the footprint A1.

If a user of one of the user terminals 11 detects an incident, for example a fallen tree on the road, this user can enter warning information into the satellite network 10. In the embodiment shown, the user (here the user of the user terminal 11c) enters warning information. The user of the user terminal 11c is therefore referred to as the notifying user. The warning information can be generated by way of an entry unit that is integrated in the user terminal 11c (see FIG. 2) or connected to the user terminal 11c. The warning information is transmitted to the management unit 101 via the satellite 100a of the satellite network 10. The satellites whose footprints cover the position of the incident transmitted with the warning information - here the position of the fallen tree - or are adjacent to this position are determined in the management unit 101 or a distribution point, not shown in FIG. 3, which may be integrated in the management unit 101 or may be connected to the management unit 101. In the embodiment of FIG. 3, the satellites 100a, 100b can be determined. The satellites 100a, 100b are therefore used to transmit the warning information to the user terminals 11a to 11f situated in the footprints A0 and A1. Although not shown in FIG. 3, it is also within the scope of the invention for the warning information not to be transmitted to the user terminal 11c from which the warning information was entered.

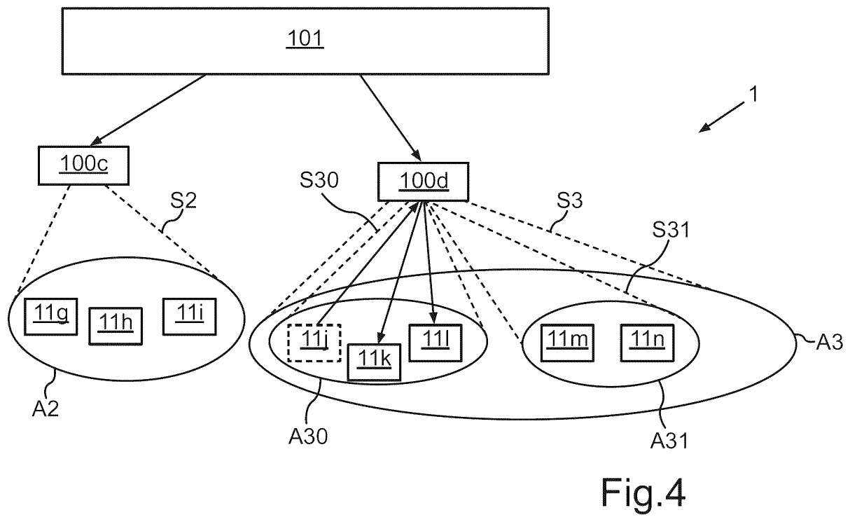

The embodiment according to FIG. 4 differs from the embodiment shown in FIG. 3 in that, in the embodiment according to FIG. 4, the satellite beam S3 of the satellite 100d can be divided into multiple satellite beams S30, S31. The satellite beam S30 covers the footprint A30 and the satellite beam S31 covers the footprint A31.

In the embodiment shown in FIG. 4, for example when the warning information from the user terminal 11j is entered by way of the satellite beam S30, the warning information can be transmitted to the user terminals 11j, 11k, 11l situated in the footprint 30 by way of the same satellite beam S30, whereas the warning information is not transmitted by way of the satellite beam S31 of the satellite 100d.

The present invention therefore allows satellite networks to be used to send messages selectively per region (for example for the footprint of one satellite beam). This means that users, who can also be referred to as utilizers, can be informed about local matters when local incidents such as forest fires, landslides, floods and the like occur in a specific region without a mobile radio network, for example.

Data transmission, in particular the transmission of warning information, via satellite is preferably switched on only if a data connection via the terrestrial network is not possible. The transition in this case is preferably seamless.

The present invention allows users whose user terminal is integrated in a motor vehicle or connected to the motor vehicle, and who can therefore also be referred to as drivers, to inform one another in a simple manner. If a driver finds, for example on a trip through a national park or other remote stretch, that a tree is lying across the road or a bridge has collapsed, the driver can transmit the relevant incident, which can also be called an event, by satellite to a central platform, in particular a management unit. For this, the driver can select the position, the suspected extent and the event type (incident type). The warning information, which can also be referred to as data, can then be stored in a central cloud and distributed to other vehicles.

Overall, the examples show how a satellite-based broadcast can be delivered to specific devices.

### REFERENCE SIGNS

1 information system
10 satellite network
100 satellite
101 management unit
11 user terminal
110 entry unit
111 antenna
112 modem
113 switching device
12 motor vehicle
A0, A1, A2, A3, A30, A31 footprints
S0, S1, S2, S3, S30, S31 Satellite Beam.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method of delivering warning information in an information system, the information system comprising:
a satellite network; and
a plurality of user terminals, warning information being transmitted to at least one user terminal among the plurality of user terminals of the information system,
wherein the warning information is entered into the information system via the satellite network by a user who notifies the information system by way of a user terminal of the user and/or via an interface of the satellite network and is transmitted via the satellite network to the at least one user terminal among the plurality of user terminals of the information system that is associated with another user.

2. The method according to claim 1, wherein the warning information comprises at least two parameters, which are an incident and a position of the incident.

3. The method according to claim 1, wherein the warning information is generated by the user.

4. The method according to claim 2, wherein the warning information is generated by the user.

5. The method according to claim 3, wherein the warning information is generated by the user using an entry unit that predetermines a list for selection by the user for at least one parameter of the warning information.

6. The method according to claim 5, wherein position of an incident comprised in the warning information being determined by an entry unit by using position information determined by the satellite network.

7. The method according to claim 1, wherein the warning information is transmitted to user terminals, among the plurality of user terminals, which are situated in predefined surroundings of a position of an incident.

8. The method according to claim 2, wherein the warning information is transmitted to user terminals among the plurality of user terminals, which are situated in predefined surroundings of the position of the incident.

9. The method according to claim 3, wherein the warning information is transmitted to user terminals among the plurality of user terminals, which are situated in predefined surroundings of a position of an incident.

10. The method according to claim 4, wherein the warning information is transmitted to user terminals among the plurality of user terminals, which are situated in predefined surroundings of the position of the incident.

11. The method according to claim 1, wherein the warning information is entered by the user by way of a satellite beam of a satellite of the satellite network and is transmitted to the at least one user terminal of at least one other user by way of that satellite beam.

12. An information system for delivering warning information in the information system, the information system comprising:
a satellite network; and
a plurality of user terminals,
wherein the satellite network is designed to transmit warning information to at least one user terminal among the plurality of user terminals and the information system comprises an entry unit that is configured to be used by a user to enter warning information into the information system.

13. The information system according to claim 12, wherein the entry unit is connected to a user terminal of the user or integrated in the user terminal of the user.

14. The information system according to claim 12, wherein the entry unit comprises a user interface that is enabled to allow the user to input predefined parameters of alerts.

15. The information system according to claim 13, wherein the entry unit comprises a user interface that is enabled to allow the user to input predefined parameters of alerts.
